(19) United States
(12) Patent Application Publication
(10) Pub. No.: US 2009/0182910 A1
(43) Pub. Date: Jul. 16, 2009

(54) Computer interface control device

(75) Inventor: Cheng-Hung Huang, Taipei County (TW)

Correspondence Address: BACON & THOMAS, PLLC, 625 SLATERS LANE, FOURTH FLOOR, ALEXANDRIA, VA, 22314-1176, US

(73) Assignee: Tenx Technology Inc., Taipei County (TW)

(21) Appl. No.: 12/213,631

(22) Filed: Jun. 23, 2008

(30) Foreign Application Priority Data
Jan. 15, 2008 (TW) 97200900

(51) Int. Cl. G06F 13/12; G06F 3/00; G06F 9/44

(52) U.S. Cl. 710/63; 710/11; 719/321

(57) ABSTRACT

The computer interface control device of this invention comprises: a computer interface control unit, a central control unit, a driver program memory, a selective data transmission unit, a selective data transmission control unit and a data transmission interruption unit. The central control unit is in connection with the computer interface control unit. The driver program memory is in connection with the computer interface control unit and the central control unit. The selective data transmission unit and the selective data transmission control unit are in connection with the computer interface control unit. The selective data transmission control unit controls the selective data transmission unit in switching among different transmission channels, according to the functionalities of the peripheral devices in connection with the computer interface control device.

### FIELD OF THE INVENTION

The present invention relates to a computer interface control device, especially referring to a computer interface device that transmits data in a channel selected according to the functionalities of a peripheral device in connection with the computer interface control device.

### BACKGROUND OF THE INVENTION

The USB interface is one of the most popular computer interfaces in the market. Many portable electronic products use the USB interface to communicate with the compute device. The USB interface provides a very useful data and control signal communication channel for the computer peripheral devices in relation with the computer device. In most peripheral devices that support the USB interface functions, however, it is necessary to provide for each product a particular USB interface control device. Although in some products two or more computer interface controllers are integrated into one control device, so that the integrated computer interface control device would support two different peripheral devices, such a compute interface control device would imply support the functionalities of the particular products. In order to provide a new peripheral device to be workable with the computer device, a new computer interface control device needs to be designed. The provider of the new product may either design the computer interface control device by itself or design the peripheral device in a way that would be supported by the commercially available computer interface control devices. Neither approach is convenient.

Therefore, it is desirable in the industry to provide a computer interface control device that is able to support a plurality of the peripheral devices that need to communicate with the computer device through the computer communication interface.

It is also necessary to provide a novel computer interface control device to resolve the drawbacks in the conventional computer interface controller technology.

Taking the USB interface as an example, it is necessary to provide a novel USB interface control device that supports the USB mouse, the USB recording microphone, the USB telephone set, the USB wireless remote controller, the USB memory stick, the USB card reader, the USB fingerprint reader and the USB keyboard.

### OBJECTIVES OF THE INVENTION

The objective of this invention is to provide a novel compute interface control device that supports a plurality of the peripheral devices.

Another objective of the invention is to provide a compute interface control device whereby a plurality of peripheral devices may communicate with the computer device through such compute interface control device.

Another objective of the invention is to provide a computer interface control device that selects the communication channels between a peripheral device and the computer device according to the functional settings by the user.

Another objective of the invention is to provide a computer interface control device that selects the communication channels between a peripheral device and the computer device according to the functional settings provided by the manufacture of the peripheral device.

Another objective of this invention is to provide a data transmission system that allows the user to execute a peripheral device installation program in the computer device and establishes the communication channels between a peripheral device and the computer device according to the settings that the user made in the peripheral device installation program.

Another objective of this invention is to provide a two-channeled selective data transmission controller that activates a peripheral device installation program, which controls the operation of the two-channeled selective data transmission controller. The two-channeled selective data transmission controller announces to the computer device the installation of the peripheral devices in connection and selects the communication channels, when the two-channeled selective data transmission controller is in connection with the computer device.

Another objective of the invention is to provide a peripheral device installation program executable by the operation system of the computer device. The peripheral device installation program changes the settings of the computer interface control device and selects the communication channels between a portable peripheral device and the computer device.

Another objective of the invention is to provide a computer interface control device that supports a plurality of portable peripheral devices that use the same computer interface to communicate with the computer device.

### SUMMARY OF THE INVENTION

In order to solve the problems in the conventional computer interface control device, a novel computer interface control device is provided. The invented computer interface control device supports a plurality of peripheral devices that use the same computer interface to communicate with the computer device. The invented computer interface control device connects a peripheral device to the computer device. After the peripheral device is in connection with the computer device, the invented computer interface control device will start to negotiate with the operation system of the computer device, according to the default settings of the computer interface control device, in order to establish the initial communication channel between the peripheral device and the computer device. Thereafter, a peripheral device installation program is operated by the operation system of the computer device, allowing the user to select the functionalities of the peripheral device.

After the user has selected the functionalities of the peripheral device, the invented compute interface control device allows the peripheral device installation program to change the functional settings, and the data transmission channel, of the computer interface control device. At the same time, the default settings that were previously stored in the operation system of the computer device will be replaced by new functional settings.

The features of the present invention include: The computer interface control device may adapt itself to the functionalities of the particular peripheral devices that is currently in connection with the computer interface control device and represented by the newly selected functional settings. The data transmission between the computer interface control device and the connected peripheral devices may go through the data transmission channel selected according to the functional settings in relating to the peripheral device currently in connection. In the peripheral device installation the user may select the transmission channel between the computer interface control device and the connected peripheral devices. The user may also select the data transmission channel by setting a switch provided in the peripheral devices.

The present invention provides the possibility of integrating into a single IC chip a computer interface control device that supports the transmission between a peripheral device and the computer device of various types of data, including the video data, the audio data, the text data and other type of data. The transmission channel of these data may be selected by the operation system of the computer device using the peripheral device installation program.

The present invention provides a novel computer interface control device for the portable peripheral devices. Upon the activation by a selective data transmission control unit provided in the invented computer interface control device, the operation system of the computer device will execute a peripheral device installation program so to instruct the selective data transmission control unit to select the data transmission channel between the peripheral device and the computer device. The computer interface control device of the present invention comprise: A computer interface control unit, a central control unit, a driver program memory, a selective data transmission unit, a selective data transmission control unit and a data transmission interruption unit. Among them, the central control unit is in connection with the computer interface control unit and the driver program memory is in connection with the computer interface control unit and the central control unit. The selective data transmission unit is in connection with the computer interface control unit and the selective data transmission control unit is in connection with the computer interface control unit. The data transmission interruption unit is in connection with the computer interface control unit.

The computer interface control device of the present invention is able to execute a peripheral device installation program, which provides instructions to the selective data transmission control unit to select the data transmission channel between the peripheral device and the computer device in connection with the computer interface control device.

In another embodiment of the present invention, the computer interface control device is in connection with a peripheral device, an external memory device and a computer device and comprises a computer interface control unit, a central control unit, a driver program memory, a selective data transmission unit, a selective data transmission control unit and a data transmission interruption unit. The computer interface control unit is in connection with the central control unit and communicates with the computer device through a communication interface. The central control unit is in connection with the computer interface control unit and controls the peripheral interfacing application functions of the computer interface control unit. The driver program memory is in connection with the computer interface control unit and the central control unit and stores the driver programs for a variety of peripheral devices.

In this embodiment, the selective data transmission unit is in connection with the computer interface control unit and selects the data transmission channels of the computer interface control device. The selective data transmission control unit is in connection with the selective data transmission unit and controls the selective data transmission unit to select the method for data transmission of the computer interface control device. The data transmission interruption unit is in connection with the computer interface control unit and interrupts the data transmission of the computer interface control device.

The present invention also provides a data transmission system, comprising a computer device, a computer interface control device, an external memory device and a peripheral, wherein the computer interface device comprises a computer interface control unit, a central control unit, a driver program memory, a data transmission unit, a selective data transmission control unit and a data transmission interruption unit. When the data transmission system is activated, the compute interface control device uses the selective data transmission control unit to control the selective data transmission unit and to conduct the protocol negotiation among the peripheral device, the computer device and the external memory device.

In the present invention, the selective data transmission unit may be a bi-channel selective data transmission unit or a transmission node that is able to identify itself to the computer device as a bulk data transmission node, a data transmission interruption node or a simultaneous data transmission node and to change the identification information.

The selective data transmission control unit in the present invention is preferably a two-channel selective data transmission control unit, more preferably a two-channel selective data transmission control unit controlled by a peripheral device installation program.

The computer interface suited in the present invention may be a wired communication interface or a wireless communication interface. If it is a wired communication interface, it may be the USB interface, the PCMCIA interface, the CardBus interface, the IEEE 1394 interface or the PCI interface. If it is a wireless communication interface, it may be the infra red interface, the Blue Tooth interface or the radio interface.

The central control unit suited in the present invention may be a microcontroller or a microprocessor. The driver program memory may be an OTP ROM, a mask ROM or a stand-alone NOR flash memory. The external memory device may be a dynamic random access memory, a serial flash memory, a NOR flash memory or any type of memory card.

The computer interface control device may further comprise a bidirectional data transmission interface. The bidirectional data transmission interface may further comprise an embedded data transmission interface. The embedded data transmission interface may be the SPI interface, the SmartCard reader interface, the UART interface or the GPIO interface, or their combinations.

The peripheral devices suited in the present invention include: The keyboard, the microphone, the telephone set, the wireless remote controller, the memory stick, the card reader, the fingerprint scanner, the keypad and the mouse.

These and other objectives and advantages may be clearly understood from the detailed description by referring to the following drawings.

### BRIEF DESCRIPTION OF THE DRAWINGS

FIG. 1 is the systematic diagram of the computer interface control device of the present invention.

FIG. 2 is the flowchart for the protocol negotiation in the installation of a peripheral device initialized by the selective data transmission control unit of the present invention.

FIG. 3 is the flowchart for the protocol negotiation in the installation of a peripheral device initialized by the GPIO pin selection in the present invention.

### DETAILED DESCRIPTION OF THE INVENTION

The detailed description of the embodiments of the computer interface control unit in the present invention will be given in the followings. The present invention provides a new concept in the computer interface control device. In the present invention the data transmission channel between a peripheral device and the computer device is selected according to a selective data transmission mechanism. A variety of peripheral devices that requires the driving capabilities of the respective interface controls may be supported by one computer interface control device and properly driven by switching the computer interface control device to the respective corresponding interface controls. In the application of the present invention, a computer interface control device with the two-channel structure, for example, may be used and the USB mouse function is set as the default function of the computer interface control device. Thereby, when the user needs to connect a USB memory stick with the computer device, the user may use the mouse that is in connection with the computer interface control device to operate a peripheral device installation program in the computer device and select the USB memory stick function of the computer interface control device. Thereafter the computer interface control device of the present invention will provide the control functions for the USB mouse and the USB memory stick. When the user wishes to replace the USB memory stick with a USB card reader, the user may operate the peripheral device installation program and select the USB card reader function. Thereafter, the computer interface control device of the present invention will provide the control functions for the USB mouse and the USB card reader.

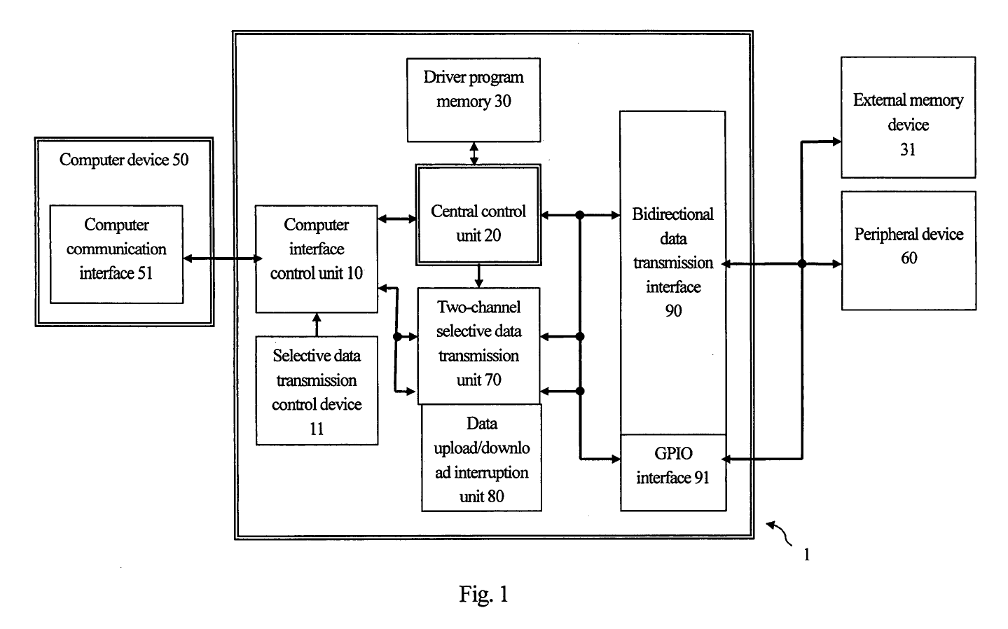

FIG. 1 is the systematic diagram of the computer interface control device of the present invention. As shown in this figure, the computer interface control device 1 of the present invention connects a peripheral device 60 and an external memory device 31 to a computer device 50 and controls the communications and the I/O operations between them. The computer interface control device 1 comprises a computer interface control unit 10, a selective data transmission control device 11, a central control unit 20, a driver program memory 30, a two-channel selective data transmission unit 70, a data upload/download interruption unit 80, a bidirectional data transmission interface 90 and a GPIO interface 91.

In the computer interface control device 1, the computer interface control unit 10 serves to control the communication and the I/O operations between the computer interface control device 1 and the computer device 50, via the computer communication interface 51. The central control unit 20 serves to control the peripheral interfacing functions of the computer interface control unit 10 and to process and to transmit the protocol negotiation information. The driver memory 30 is sued to store the driver programs of the peripheral devices to be connected with the computer interface control device 1.

The selective data transmission unit 70 provides the functions as being operable as a bulk data transmission node, a data transmission interruption node and a simultaneous data transmission node. The data upload/download interruption unit 80 is used to interrupt the data transmission between the computer interface control device 1 and the computer device 50. The selective data transmission unit 70 transmits data through the transmission channel selected by the selective data transmission control unit 11. In addition, the selective data transmission control unit 11 may further be controlled by the central control unit 20. The functional settings relating to the data transmission functions in the selective data transmission control unit 11 may be altered from time to time by the computer device 50, when the peripheral device installation program is executed. Therefore, the computer interface control device 1 has the capability of negotiating with the computer device 50 in establishing the data transmission channel, selecting the proper data transmission channel for a variety of peripheral devices and executing the data transmission operations according to the selected data transmission channel.

In the mechanism described above, the computer communication interface 51 that the invented computer interface control device 1 supports is the USB interface. This is because the USB interface is the most popular computer communication interface in the industry. However, it is understood that other communication interfaces, including the wired communication interface such as the PCMCIA interface, the CardBus interface, the IEEE 1394 interface, the PCI interface etc., and the wireless interface such as the infra red interface, the Blue Tooth interface and the radio interface, may also be used in the present invention.

The central control unit 20 may be any commercially available microcontroller or microprocessor. In this embodiment, the central control unit 20 serves to process the data provided by the computer interface control device 10, to conduct all kinds of operations and to output data to the computer communication interface 51. The selective data transmission control unit 11 and the selective data transmission unit 70 are the major technical features of this invention. The central control unit 20 uses the selective data transmission control unit 11 to select the necessary control functions to support the peripheral devices in connection with the computer interface control device and, accordingly, to select the data transmission channel for the selective data transmission unit 70. According to the data transmission channel being selected, the selective data transmission control unit 11 announces to the computer device a peripheral in connection with the selected data transmission channel, to request the establishment of a corresponding data communication channel. In response, the computer device 50 will generate a communication channel that supports the type of peripheral devices that the computer interface control device 1 announces to the computer device. Thereafter, a peripheral device installation program stored in the computer device is executed, whereby the driver programs of the announced peripheral devices 60 is provided to the computer device for execution. In the following, the application programs of the peripheral devices 60 are provided to the computer device 50 and are executed in the operation system of the computer device 50. The application programs thus confirm the identification of the peripheral devices 60 and provide the functions of the peripheral devices 60.

When the user wishes to use another peripheral device in the computer interface control device 1, the user will need to change the functional settings previously made and stored. The user may use the peripheral device installation program to change these settings. Upon the receipt of the changes, the central control unit 29 uses the selective data transmission control unit 11 to remove the old settings from the computer devices 50 and install the new settings, whereby the computer device 50 will generate the corresponding negotiation interface. Thereafter, the peripheral device installation program in the computer device executes the driving operations and the activation of the related application programs, in the manner as described above.

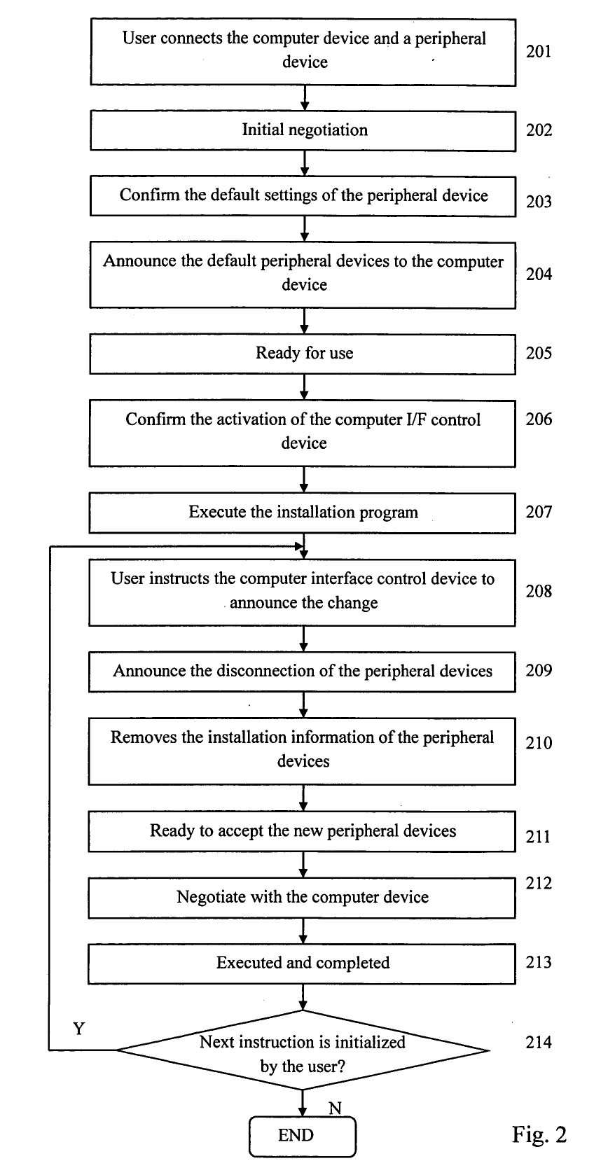

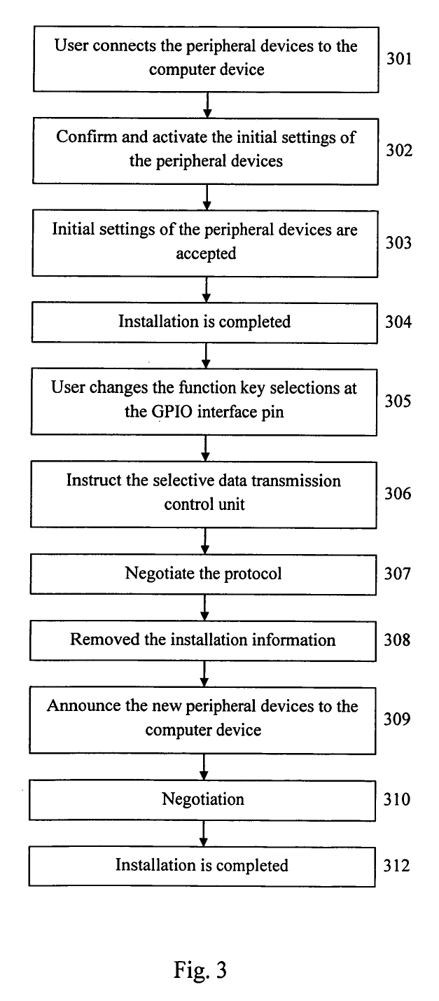

In the computer interface control device as described above, the selective data transmission unit 70 executes the protocol negotiations between the peripheral device 60 and the computer device 50 under the control of the selective data transmission control unit 11 and the central control unit 20. The flowchart of such protocol negotiations is shown in FIGS. 2 and 3.

In the data transmission system of the present invention, the selective data transmission control unit 11 controls the selective data transmission unit 70 and changes the functional settings that the computer interface control device 1 previously provided to the computer device. The selective data transmission control unit 11 also negotiates the communication protocols with the computer device 50 according to the user's selection in the peripheral device installation program.

FIG. 2 is the flowchart for the protocol negotiation process in the installation of a peripheral device, as initialized by the selective data transmission control unit of the present invention. As shown in this figure, the protocol negotiation process between the invented computer interface control device 1 and the computer device 50 starts at 201, when the user connects the computer interface control device 1 to the computer device 50 and a peripheral device 60. At 202 the computer interface control device 1 announces the initial negotiation to the computer device 50. The announcement provides the information of the types and the number of the transmission nodes provided in the computer interface control device 1. In this example, the selective data transmission unit 70 is a two-channel selective data transmission unit, i.e., a multiple type transmission node that can change from time to time the type of the data transmission node it announced to the computer device 50. For example, when the computer communication interface 51 is the USB interface, the selective data transmission unit 70 may include the data transmission interruption node that is used in the USB mouse, the bulk data transmission node that is used in the memory stick and the isochronous data transmission node that is used in the USB telephone set.

After the initial announcement of the computer interface control device 1, at 203 the computer device 50 starts to confirm the default settings of the peripheral device 60 and, upon confirmation, activates the default settings. Thereafter, at 204 the computer interface control device 1 announces the default peripheral devices to the computer device 50 according to the default settings. For example, in case of the USB interface, the default peripheral devices may be a USB mouse and a USB memory stick. After the default peripheral devices are installed with the computer device 50, at 205 the USB mouse and the USB memory stick are ready for use in the computer device 50. At 206 the computer device 50 confirms the activation of the computer interface control device 1. At 207 the peripheral device installation program is executed in the operation system of the computer device 50.

When the user connects another peripheral device, for example, a USB card reader, with the computer interface control device 1, at 208 the user uses the peripheral device installation program to instruct the computer interface control device 1 to announce the change. At 209 the computer interface control device 1 announces the disconnection of the peripheral devices. At 210 the computer device 50 removes the installation information of the peripheral devices from the operation system. At 211 the computer device 50 is ready to accept the announcement of the new peripheral devices. In this example, the peripheral devices to be announced are a USB mouse and a USB card reader. At 212 the computer interface control device 1 starts to negotiate with the computer device 50 and announces to the operation system of the computer device 50 a USB mouse and a USB card reader. At 213 the installation of the USB mouse and the USB card reader is executed and completed.

After the completion of the installation, the computer interface control device 1 stands by at 214 until the next installation instruction is initialized by the user. When the user connects another peripheral device, such as a USB telephone handset, with the computer interface control device 1, the same process is executed to announce the USB mouse and the USB telephone handset to the computer device 50.

In the computer interface control device 1 of the present invention, the user may select in the function keys at the GPIO interface 91 pin to reinstall the peripheral devices.

FIG. 3 is the flowchart for the protocol negotiation in the installation of a peripheral device initialized by the GPIO interface pin selection in the present invention. As shown in this figure, before the peripheral devices are connected to the computer interface control device 1 the user needs to preset the function key selections at the GPIO interface pin. When the user connects the peripheral devices to the computer device 50 at 301, the computer starts to confirm and activate the initial settings of the peripheral devices at 302. After the initial settings of the peripheral devices are accepted, at 303 the computer interface control device 1 announces to the computer device 50 the peripheral devices of, for example, a USB mouse and a USB memory stick, according to the initial settings. At 304 the installation is completed and the user is thus allowed to use the USB mouse and the USB memory stick in the computer device 50.

When the user wishes to disconnect the USB memory stick and connect a USB card reader, at 305 the user changes the function key selections at the GPIO interface pin 91. Thereby, at 306 the computer interface control device 1 uses the central control unit 20 to instruct the selective data transmission control unit 11 to change the identity information of the peripheral device in use, from a USB memory stick to a USB card reader. At 307 the computer device 50 and the computer interface control device 1 start to negotiate the protocol. At 308 the installation information of the previously installed peripheral devices is removed from the operation system of the computer device 50. At 309 the central control unit 20 instructs the selective data transmission control unit 11 to announce to the computer device 50 the new peripheral devices, i.e., a USB mouse and a USB card reader. The computer interface control device 1 starts to negotiate with the computer device 50 at 310 and announces to the operation system of the computer device 50 the USB mouse and the USB card reader. At 312 the installation is executed and completed.

If the user wishes to change the USB card reader to a USB telephone, the user simply needs to change the function key selection at the GPIO interface pin. The above-mentioned steps are repeated and the installation of the USB mouse and the USB telephone set is completed at the same time.

The computer interface control device of this invention may further include a data upload/download interruption unit 80, to announce to the computer device 50 that the peripheral device 60 is a standard product, such as a standard keyboard or a standard mouse. As a result of such announcement, the peripheral 60 is operable in the computer device 50 as soon as it is in connection.

A computer interface control device 1 comprising all or parts of the above-described elements has provided the control and communication interfaces for most peripheral devices. Therefore, it has the capability of supporting most peripheral devices in their communication with the computer device. The present invention may be used as the computer interface controller for one single peripheral device or for the combination of a plurality of peripheral devices.

As the present invention has been shown and described with reference to preferred embodiments thereof, those skilled in the art will recognize that the above and other changes may be made therein without departing form the spirit and scope of the invention.

What is claimed is:

1. A computer interface control device to connect a peripheral device, an external memory and a computer device, said computer interface control device comprising:
a computer interface control unit to communicate with said computer device through a computer communication interface and to control the input and output operations of said peripheral in relation to said computer device;
a central control unit in connection with said computer interface control unit, to control the interfacing functions of said computer interface control unit;
a driver program memory in connection with said computer interface control unit and said central control unit, to store the driver program of at least one kind of peripheral device;
a selective data transmission unit in connection with aid computer interface control unit, to provide at least two data transmission channels;
a selective data transmission control unit in connection with said computer interface control unit, to control said selective data transmission unit in switching between said data transmission channels; and
a data transmission interruption unit in connection with said computer interface control unit, to interrupt the data transmission of said computer interface control device; wherein:
said selective data transmission control unit selects said data transmission channels between said computer interface control device and said computer device according to product functional settings input by a user through an application program or a control key.

2. The computer interface control device according to claim 1, wherein said selective data transmission unit is a two-channel selective data transmission unit.

3. The computer interface control device according to claim 1, wherein said selective data transmission unit functions as a bulk data transmission node, a data transmission interruption node and an isochronous data transmission node.

4. The computer interface control device according to claim 2, wherein said selective data transmission control unit is a two-channel selective data transmission control unit.

5. The computer interface control device according to claim 1, wherein said data transmission interruption unit is one selected from the group consisted of a data upload interruption unit, a data download interruption unit and a data upload/download interruption unit.

6. The computer interface control device according to claim 1, wherein said computer communication interface is one selected from the group consisted of the USB interface, the wired communication interface and the wireless communication interface.

7. The computer interface control device according to claim 6, wherein said wired communication interface is one selected from the group consisted of the PCMCIA interface, the CardBus interface, the IEEE 1394 interface and the PCI interface.

8. The computer interface control device according to claim 6, wherein said wireless communication interface is one selected from the group consisted of the infrared communication interface, the Blue Tooth interface and the radio communication interface.

9. The computer interface control device according to claim 1, wherein said driver program memory is one selected from the group consisted of the OTP ROM, the mask ROM and the stand-alone NOR type flash memory.

10. The computer interface control device according to claim 1, further comprising a bidirectional data transmission interface.

11. The computer interface control device according to claim 10, wherein said bidirectional data transmission interface further comprises an embedded data transmission interface.

12. The computer interface control device according to claim 11, wherein said embedded data transmission interface is one selected from the group consisted of the SPI interface, the SmartCard reader interface, the UART interface, the GPIO interface and their combinations.

13. The computer interface control device according to claim 1, wherein said peripheral device is a keyboard.

14. The computer interface control device according to claim 1, wherein said peripheral device is a mouse.

15. A data transmission system, comprising:
a computer device comprising a communication interface;
a computer interface control device in connection with said communication interface;
a peripheral device in connection with said computer interface control device; and
an external memory device in connection with said computer interface control device;
wherein said computer interface control device comprises:
a computer interface control unit in connection with said communication interface, to communicate with said computer device and to control the input and output operations of said computer device;
a central control unit in connection with said computer interface control unit, to control the interfacing functions of said computer interface control unit;
a driver program memory in connection with said computer interface control unit and said central control unit, to store the driver program of at least two kinds of peripheral device;
a selective data transmission unit in connection with aid computer interface control unit, to provide at least two data transmission channels;
a selective data transmission control unit in connection with said computer interface control unit, to control said selective data transmission unit in switching between said data transmission channels; and
a data transmission interruption unit in connection with said computer interface control unit, to interrupt the data transmission of said computer device; wherein:
said selective data transmission control unit performs the protocol negotiations with said peripheral device, said computer device and said external memory.

16. The data transmission system according to claim 15, wherein said computer interface control device selects said data transmission channels according to product functional settings input by a user through an application program or a control key.

17. The data transmission system according to claim 15, wherein said selective data transmission unit is a two-channel selective data transmission unit.

18. The data transmission system according to claim 15, wherein said selective data transmission unit functions as a bulk data transmission node, a data transmission interruption node and an isochronous data transmission node.

19. The data transmission system according to claim 17, wherein said selective data transmission control unit is a two-channel selective data transmission control unit.

20. The data transmission system according to claim 15, wherein said communication interface is the USB interface.

21. The data transmission system according to claim 15, wherein said computer interface control device is a USB interface controller.
